(19) United States
(12) Patent Application Publication
(10) Pub. No.: US 2006/0018499 A1
(43) Pub. Date: Jan. 26, 2006

(54) Acoustic resonator/diffuser system and method

(75) Inventors: Nicolas E. Guyot, Pompano Beach, FL (US); Joseph M. Friedman, Plantation, FL (US); Eric S. Penrod, Sunrise, FL (US); Francis M. Staszesky, Fort Lauderdale, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 10/897,701

(22) Filed: Jul. 23, 2004

(51) Int. Cl. H04R 25/00

(52) U.S. Cl. 381/347; 381/345

(57) ABSTRACT

An acoustic system (100) includes a resonant cavity (106) that enhances an audio sound pressure signal produced by a transducer (102) and provides the enhanced audio sound pressure signal to a diffuser cavity (110) and an acoustic cover (120) to diffuse the sound pressure output signal across a greater area to facilitate properly placing the acoustic system (100) to a user's ear. Incorporation of the acoustic system (100) into a portable electronic device, such as a cellular telephone, provides an acoustically optimized and physically small audio generator that is easily located along a user's ear.

### FIELD OF THE INVENTION

The present invention generally relates to the field of acoustic systems, and more particularly relates to acoustic systems incorporating acoustic resonators and diffusers closely coupled to the ear.

### BACKGROUND OF THE INVENTION

The acoustic response of a system and the ease at which the user can locate the system to his/her ear both influence the perceived audio performance of an earpiece of an electronic device. The ease with which the user can locate the acoustic system is primarily a function of the surface area through which the phone emits sound. This area is influenced by the number, size, and relative location of ports that lead from the earpiece transducer to the listening surface of the phone. An acoustic system that has multiple ports spread over a large surface will be easily located by the user.

The acoustic response of an earpiece system can be enhanced by designing an acoustic resonator between the earpiece transducer and the listening surface of the device. This resonator often includes a small resonant air volume that is directly in front of the transducer. The resonator also includes a single, small port connecting that small air volume with the listening surface of the device. Generally, an acoustic resonator of this form severely compromises the ease with which the user is able locate the acoustic system to his/her ear. In order to improve the ease with which the user can locate the acoustic system, holes are added to the system. These additional holes, however, cause a loss of the resonating effects. As a result, designers select among trade offs between acoustic response and the ease with which the user can locate the acoustic system.

Therefore a need exists to overcome the problems with the prior art as discussed above.

### SUMMARY OF THE INVENTION

Briefly, in accordance with the present invention, an acoustic system has an acoustic transducer for producing a first sound pressure signal and at least one acoustic resonator that is located in proximity to the acoustic transducer and that accepts the first sound pressure signal. The acoustic resonator produces a second, enhanced sound pressure signal. The acoustic system further has at least one acoustic diffuser that accepts the second, enhanced sound pressure signal and diffuses the second, enhanced sound pressure signal.

In accordance with another aspect of the present invention, a method for producing sound pressure signal includes generating a first sound pressure signal, creating a second, enhanced sound pressure signal by creating a resonance for the first sound pressure signal, and diffusing the second sound pressure signal.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an acoustic system according to an exemplary embodiment of the present invention.

FIG. 2 is a detailed illustration of the back sides of acoustic resonator and acoustic diffuser in accordance with an exemplary embodiment of the present invention.

FIG. 3 illustrates an exploded view of an electronic device incorporating an acoustic system according to the exemplary embodiment of the present invention.

FIG. 4 illustrates an electronic device front view according to the exemplary embodiment of the present invention.

FIG. 5 illustrates a cut-away internal down view “A” as is denoted in FIG. 4 of an acoustic system for an electronic device in accordance with an exemplary embodiment of the present invention.

FIG. 6 illustrates a cut-away internal side view “B” as is denoted in FIG. 4 of an acoustic system for an electronic device in accordance with an exemplary embodiment of the present invention.

FIG. 7 illustrates a cellular phone block diagram according to an exemplary embodiment of the present invention.

FIG. 8 illustrates an acoustic sound pressure generation processing flow diagram according to an exemplary embodiment of the present invention.

FIG. 9 illustrates a first alternative acoustic system in accordance with the present invention.

FIG. 10 illustrates a second alternative acoustic system in accordance with the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The exemplary embodiments of the present invention, as described below, provide a physically small and power efficient sound generating acoustic system that can be easily placed at a proper location relative to a user's ear.

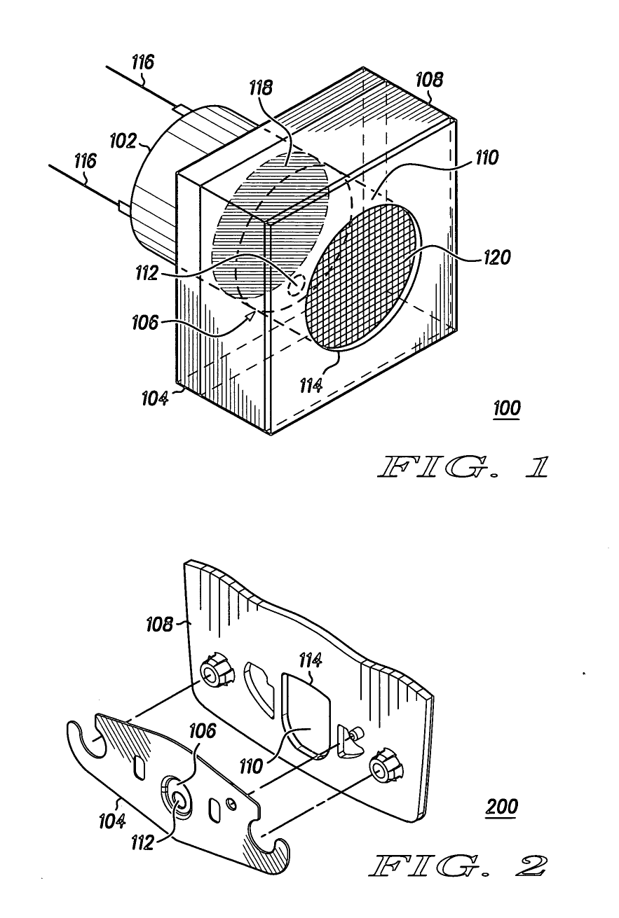

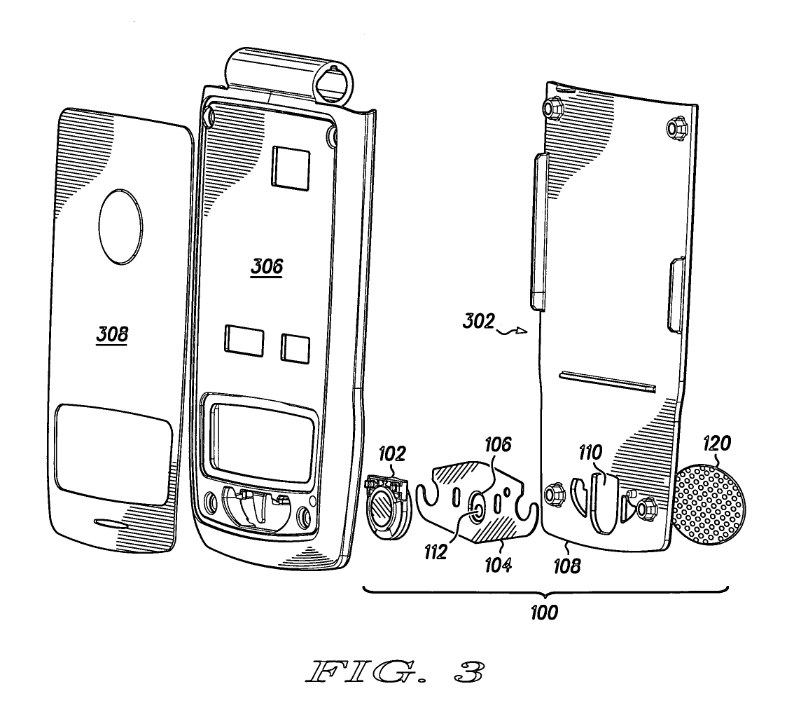

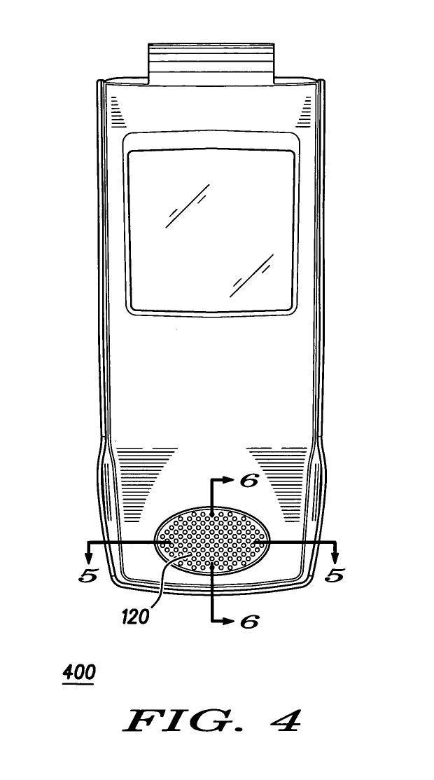

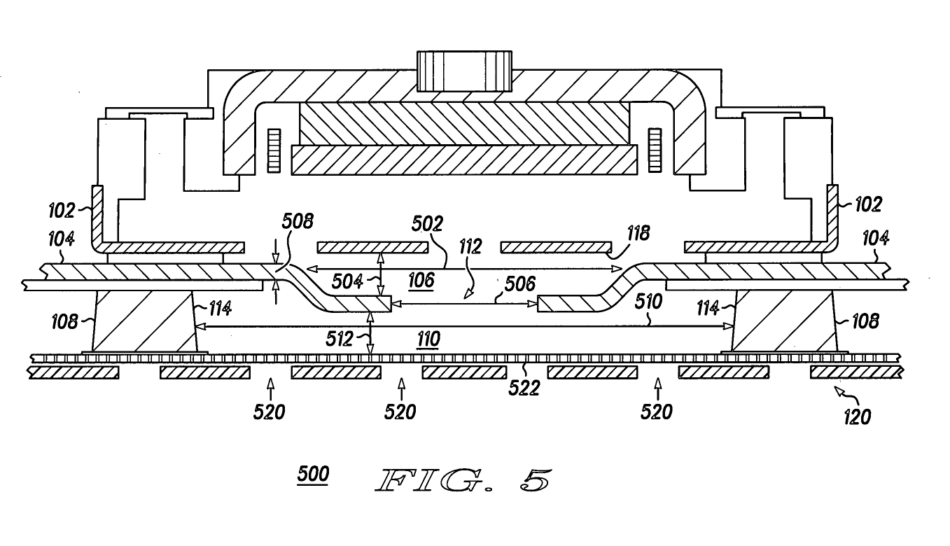

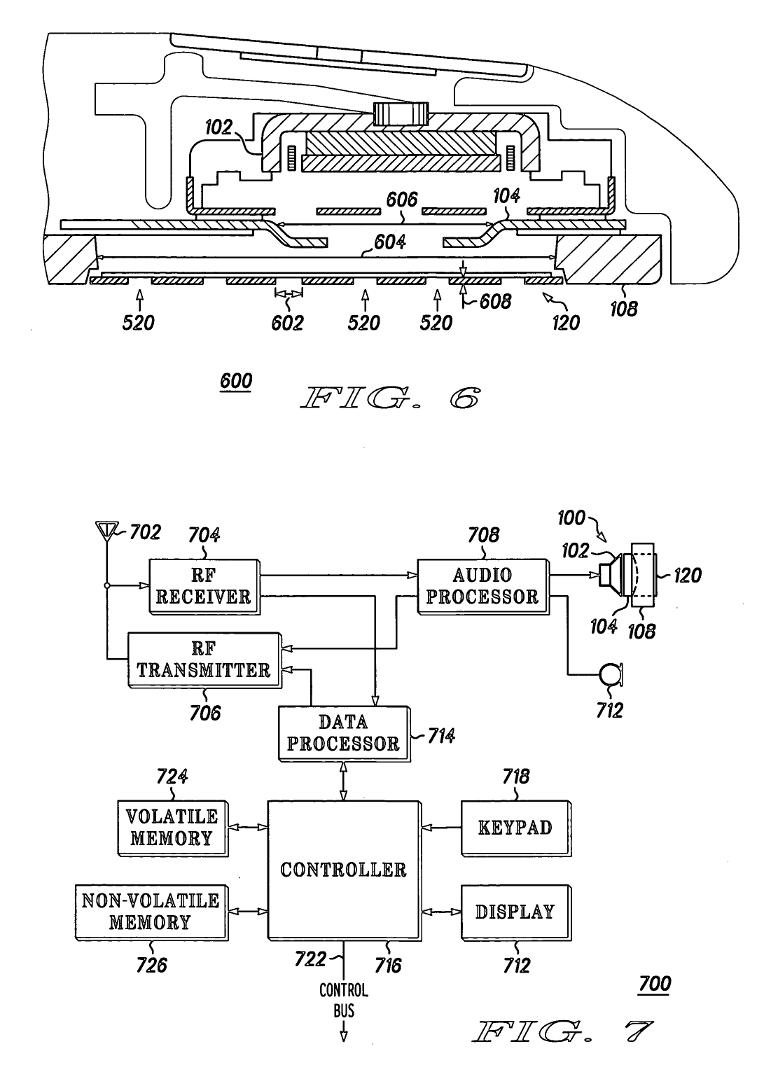

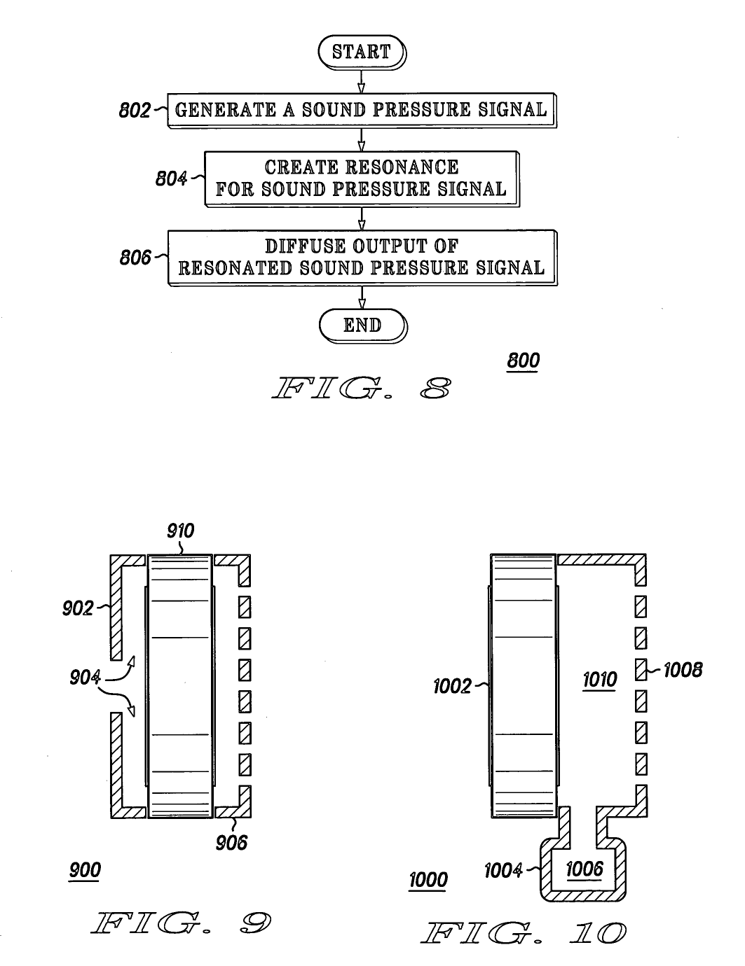

FIG. 1 illustrates an acoustic system 100 according to an exemplary embodiment of the present invention. Acoustic system 100 includes an acoustic transducer 102 that accepts an electrical signal over input wires 116 and generates an acoustic sound pressure output signal at its face 118. The acoustic transducer of the exemplary embodiment is an electromagnetic speaker acoustic transducer that produces a sound pressure output at its face 118. Further embodiments of the present invention incorporate any type of acoustic transducer, including but not limited to piezo-electric acoustic transducers

The acoustic system 100 of the exemplary embodiment further includes an acoustic resonator 104. Acoustic resonator 104 has a back end that is in proximity to, and is adjacent to by being attached in this exemplary embodiment to, the acoustic transducer's face 118. The acoustic resonator 104 forms a resonant volume within a resonant cavity 106 that is shown here in outline but further described below. The resonant cavity 106 is in proximity to the output of the acoustic transducer 102 in the exemplary embodiment. The resonant cavity 106 of the exemplary embodiment has a single acoustic output port 112 on the front end of the acoustic resonator 104, which is the end opposite the back end of the acoustic resonator 104, i.e., the end that is connected to the acoustic transducer 102. The operation of the acoustic resonator 104, and particularly the resonant cavity 106 defined by the acoustic resonator 104, improves the acoustic performance of the acoustic transducer 102 as is known by ordinary practitioners in the relevant arts. The resonant cavity 106 of the exemplary embodiment is optimized for voice signals, and is designed to resonate in the area of three Kilohertz (KHz). Further embodiments design resonant cavities 106 and output port 112 to resonate at different frequencies in order to emphasize other types of audio. Various embodiments of the present invention also include one or more output ports 112. The acoustic resonator accepts the sound pressure signal from the acoustic transducer 102 and produces an enhanced sound pressure signal at the output port 112. Further embodiments include a resonator to produce enhanced sound pressure signal at other locations, such as at the front of an acoustic transducer or at an acoustic output port, as is discussed below.

The acoustic system 100 of the exemplary embodiment further includes an acoustic diffuser housing 108. Acoustic diffuser housing 108 of the exemplary embodiment forms a diffuser cavity 110 that is a small air volume that is located in proximity to the front of the single resonator port 112. In the exemplary embodiment, the diffuser cavity 110 is directly in front of the resonator output port 112 and receives the sound pressure output of the acoustic resonator 104 as is delivered through the resonator output port 112. The diffuser cavity 110 of the exemplary embodiment has an acoustic cover 120 at its output end, which is the end opposite the acoustic resonator output port 112. The acoustic cover 120 has multiple diffuser output ports that connect the diffuser cavity 110 to a listening surface of a device incorporating the acoustic system 100. The acoustic cover 120 and diffuser cavity 110 in the exemplary embodiment form an acoustic diffuser to diffuse enhanced sound pressure signals produced by the combination of acoustic transducer 102 and acoustic resonator 104.

The acoustic diffuser housing 108 of the exemplary embodiment accepts the sound pressure output from the acoustic resonator output port 112 and diffuses/spreads this sound pressure acoustic signal across an area of the surface of the acoustic cover 120 of the acoustic system 100. Diffusing/spreading this sound pressure signal across this greater area facilitates properly locating the sound system 100 at the ear of the user. The acoustic diffuser housing 108, in combination with the acoustic resonator 104, creates an acoustic system 100 that is able to be optimized for both performance and ease of location without compromising either of these properties.

FIG. 2 is a detailed illustration of the back sides of acoustic resonator 104 and acoustic diffuser housing 108 in accordance with an exemplary embodiment of the present invention. The acoustic resonator 104 of the exemplary embodiment is formed from stamped metal. Further embodiments utilize other materials to form the acoustic resonator 104 such as molded plastics and other such materials. The acoustic diffuser housing 108 and acoustic cover 120 are similarly able to be constructed of various materials.

The back side of acoustic resonator 104 is shown to form the resonant cavity 106 by a stamped recess on the back surface of acoustic resonator 104. This stamped recess includes the output port 112 as a single output hole within the sheet metal that forms the stamped recess. Acoustic diffuser housing 108 of the exemplary embodiment is a molded part that is molded to form a diffuser cavity 110. Hole 114 is molded in the acoustic diffuser housing 108.

FIG. 3 illustrates an exploded view of an electronic device 300 incorporating an acoustic system 100 according to the exemplary embodiment of the present invention. The exploded view of the electronic device 300 in the exemplary embodiment shows the top part of a flip-type cellular phone that includes an acoustic system 100, as is described above. Flip-type cellular phone designs are well known to ordinary practitioners in the relevant arts. Further embodiments incorporate an acoustic system according to the present invention, such as the exemplary acoustic system 100, into other types of cellular phones, such as monolith type cellular phones. Further embodiments incorporate an acoustic system according to the present invention into other types of audio devices, including but not limited to audio devices that process digitized audio information, such as MP3 players and other devices that produce audio sounds.

The acoustic diffuser housing 108 is formed as part of a lens structure 302 in the exemplary embodiment. Lens structure 302 of the exemplary embodiment includes a clear plastic structure that covers an alphanumeric display for the electronic device (not shown). Acoustic diffuser housing 108 has a diffuser cavity 110 that is covered by acoustic cover 120 on the end opposite the end of the diffuser cavity 110 that is in proximity to the output port 112 of the resonant cavity 106.

The exploded view of an electronic device 300 includes a device back structure 306 that forms a sturdy support structure for the electronic device. A metallic back 308 is further included to provide an aesthetically pleasing appearance for the electronic device. The acoustic transducer 102 and acoustic resonator 104 are placed between the device back structure 306 and the lens structure 302. Acoustic cover 120 is placed on the side of the lens structure 302 that is opposite the side of the lens structure in contact with the acoustic resonator 104.

FIG. 4 illustrates an electronic device front view 400 according to the exemplary embodiment of the present invention. Front view 400 illustrates a front view of the top part of the flip-type cellular phone as is illustrated in FIG. 3. The acoustic cover 120 is illustrated in this front view 400. The other components of the acoustic system 100 are located behind acoustic cover 120 in this exemplary embodiment. Front view 400 further illustrates the orientation of an internal down view “A” and an internal side view “B” as are illustrated in the following figures.

FIG. 5 illustrates an internal down view “A” 500 as is denoted in FIG. 4 of an acoustic system 100 for an electronic device in accordance with an exemplary embodiment of the present invention. Internal down view 500 illustrates a sound transducer 102, an acoustic resonator 104 and an acoustic diffuser housing 108 in their assembled positions. An acoustic cover 120 is shown at the outside end of acoustic diffuser housing 108. The acoustic cover 120 is further shown to have a number of diffuser ports 520 that form output ports for the diffuser cavity 110 to allow transmission of sound out of the acoustic system 100 for the user to hear. The diffuser ports 520 are physically dispersed across the acoustic cover 120 so as to facilitate location of the output of the acoustic diffuser, via the acoustic cover 120, at a proper location near a user's ear. The diffuser ports 520 further facilitate delivery of a dispersed sound pressure signal to a user's ear. Further embodiments of the present invention utilize diffuser ports that consist of one or more holes and/or one or more slots. A perforated screen 522 is also located between the diffuser ports 520 and the resonant cavity 110 in the exemplary embodiment in order to, for example, protect from foreign material and water intrusion in this design.

Internal down view 500 illustrates various dimensions for the components of the acoustic system 100 of the exemplary embodiment. The resonator cavity 106 of the exemplary embodiment has a resonator cavity width 502 of 4.30 mm and a resonator cavity depth 504, which is the distance from the edge of the resonator cavity to the acoustic transducer face 118, of 0.60 mm. The output port 112 of the resonant cavity 106 in the exemplary embodiment has a diameter of 2.00 mm. As an example, the thickness of the metal plate that forms the acoustic resonator 104 has a resonator wall thickness 508 of 0.20 mm.

The acoustic diffuser cavity 110 of the exemplary embodiment has a diffuser cavity width 510 of 7.30 mm. The diffuser depth 512 of the exemplary embodiment, which is the distance from the inside surface of the acoustic cover 120 to the protruding edge of the sound resonator 104, is 0.70 mm.

FIG. 6 illustrates an internal side view “B” 600 as is denoted in FIG. 4 of an acoustic system 100 for an electronic device in accordance with an exemplary embodiment of the present invention. Internal side view 600 illustrates various dimensions for the components of the acoustic system 100 of the exemplary embodiment as looking from the side of the acoustic device 100. The acoustic resonator cavity 106 of the exemplary embodiment has a resonator cavity height 606 of 5.00 mm. The acoustic diffuser cavity 110 of the exemplary embodiment has a diffuser cavity height 604 of 10.00 mm. Diffuser ports 520 have essentially a round cross section in the exemplary embodiment. The diffuser port diameter 602 is 0.80 mm in the exemplary embodiment. The diffuser ports 520 can have a diffuser port depth 608, which is the thickness of the material forming the acoustic cover 120, of 0.15 mm.

FIG. 7 illustrates a cellular phone block diagram 700 according to an exemplary embodiment of the present invention. The cellular phone block diagram 700 describes a cellular phone that is a device including an embodiment of the present invention. The cellular phone block diagram 700 includes an RF antenna 702, a RF receiver 704 and an RF transmitter 706. The RF transmitter 706 and RF receiver 704 are connected to the RF antenna 702 in order to support bi-directional RF communications. The cellular phone 700 is able to simultaneously transmit and receive voice and/or data signals. The RF receiver 704 provides voice data to an audio processor 708 and the audio processor 708 provides voice data to the RF transmitter 706 to implement voice communications. The audio processor 708 obtains voice signals from microphone 712 and generates audio signals that are provided to the acoustic system 100 as an input to the speaker/acoustic transducer 102, which operates as described herein. The RF receiver 704, RF transmitter 706, Audio processor 708, microphone 712 and acoustic system 100 operate to communicate voice signals to and from the cellular phone 700.

The cellular phone block diagram 700 includes a controller 716 that controls the operation of the cellular phone in the exemplary embodiment. Controller 716 is connected to the various components of the cellular phone block diagram 700 via control bus 722. Controller 716 communicates data to external devices (not shown), such as a base station and/or a server, through a wireless link. Controller 716 provides data to and accepts data from data processor 714. Data processor 714 of the exemplary embodiment performs communications processing necessary to implement over-the-air data communications to and from external devices. Data processor 714 provides data for transmission to the RF transmitter 706 and accepts received data from RF receiver 704.

Controller 716 provides visual display data to the user through display 742. Display 742 of the exemplary embodiment is a Liquid Crystal Display that is able to display alphanumeric and graphical data. Controller 716 also accepts user input from keypad 718. Keypad 718 is similar to a conventional cellular phone keypad and has buttons to accept user input in order to support operation of the exemplary embodiment of the present invention.

The cellular phone block diagram 700 further includes non-volatile memory 726. Non-volatile memory 726 stores program data and more persistent data for use by the controller 716. Data stored in non-volatile memory 726 of the exemplary embodiment can be changed under control of controller 716 if called for by particular processing performed by the controller 716. The cellular phone block diagram 700 further contains volatile memory 724. Volatile memory 724 is able to store transient data for use by processing and/or calculations performed by the controller 716.

FIG. 8 illustrates an acoustic sound pressure generation processing flow diagram 800 according to an exemplary embodiment of the present invention. The acoustic sound pressure generation processing flow begins by generating, at step 802, a sound pressure signal. The sound pressure signal is generated in the exemplary embodiment by acoustic transducer 102. The sound pressure signal generation processing flow then creates, at step 804, an acoustic resonance for the sound pressure signal. This resonance is created in the acoustic resonator 104 in the exemplary embodiment. The created resonance produces a resonator output sound pressure signal. The sound pressure signal generation processing flow then diffuses, at step 806, the resonator output sound pressure signal as an acoustic output for the device performing this process. The above described sound pressure signal generation processing flow continues for as long as sound is being generated.

FIG. 9 illustrates a first alternative acoustic system 900 in accordance with the present invention. The first alternative acoustic system 900 positions a resonator 902, with a resonant cavity 904, in proximity to the back of an acoustic transducer 910. The first alternative acoustic system 900 also locates a diffuser 906 in proximity to the front of the acoustic transducer 910. The operation of the first alternative acoustic system 900 causes an enhanced sound pressure signal to be produced at the front of acoustic transducer 910. This enhanced sound pressure signal produced at the front of acoustic transducer 910 is diffused by diffuser 906.

FIG. 10 illustrates a second alternative acoustic system 1000 in accordance with the present invention. The second alternative acoustic system 1000 includes an acoustic channel 1010 in front of an acoustic transducer 1002. The second alternative acoustic system 1000 connects a resonator 1004, with a resonant cavity 1006, to the acoustic channel 1010. The resonator 1004 in this second alternative acoustic system 1000 is not directly in the path of the acoustic sound pressure signal. The operation of the second alternative acoustic system 1000 causes an enhanced sound pressure signal to be produced at the output of acoustic channel 1010 due to the operation of resonator 1004. The second alternative acoustic system 1000 locates a diffuser 1008 in proximity to the output of the acoustic channel 1010 to diffuse the enhanced sound pressure signal. Further embodiments place one or more resonator cavities in various locations relative to one or more acoustic transducers and/or diffusers.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. An acoustic system, comprising:
an acoustic transducer for producing a first sound pressure signal;
at least one acoustic resonator, located in proximity to the acoustic transducer, that accepts the first sound pressure signal, the acoustic resonator producing a second sound pressure signal; and
at least one acoustic diffuser accepting the second sound pressure signal and diffusing the second sound pressure signal.

2. The acoustic system of claim 1, wherein the at least one acoustic resonator comprises a resonant volume located in proximity to an acoustic output of the acoustic transducer.

3. The acoustic system of claim 1, wherein the acoustic transducer comprises an electromagnetic speaker.

4. The acoustic system of claim 1, wherein the at least one resonator comprises at least one output port.

5. The acoustic system of claim 4, wherein at least one of the at least one diffuser is located in proximity to at least one of the at least one output port, the acoustic diffuser acting to diffuse the second sound pressure signal.

6. The acoustic system of claim 1, wherein the acoustic diffuser comprises a diffuser cavity with at least one diffuser port.

7. The acoustic system of claim 6, the at least one diffuser port comprising a plurality of diffuser ports, wherein the plurality of diffuser ports are physically dispersed so as to facilitate location of an output of the acoustic diffuser at a location near a user's ear.

8. The acoustic system of claim 1, wherein the at least one acoustic resonator is located in proximity to the acoustic transducer by being adjacent to the acoustic transducer.

9. A method for producing a sound pressure signal, the method comprising:
generating a first sound pressure signal;
creating a second sound pressure signal by creating a resonance for the first sound pressure signal; and
diffusing the second sound pressure signal.

10. The method of claim 9, wherein the second sound pressure is produced through a single output hole.

11. The method of claim 9, wherein the generating the first sound pressure signal comprises generating the first sound pressure signal with an electromagnetic speaker.

12. The method of claim 9, wherein the resonance for the first sound pressure signal is created by a resonant volume that accepts the first sound pressure signal.

13. The method of claim 12, wherein the resonance for the first sound pressure signal is created by the resonant volume and at least one port, the resonant volume accepting the first sound pressure signal.

14. The method of claim 9, where the diffusing comprises passing the second sound pressure signal through at least one diffuser cavity with at least one diffuser port.

15. The method of claim 14, wherein the diffuser ports are physically dispersed so as to facilitate delivery of a dispersed sound pressure signal to a user's ear.

16. An audio device, comprising:
at least one an audio processor for generating an audio signal;
at least one an acoustic transducer, electrically coupled with the audio processor, for producing a first sound pressure signal;
at least one an acoustic resonator, located in proximity to at least one of the at least one acoustic transducer, for receiving the first sound pressure signal, the at least one acoustic resonator having at least one output port that produces a second sound pressure signal; and
at least one an acoustic diffuser located in proximity to at least one of the at least one output port, the at least one acoustic diffuser acting to diffuse the second sound pressure signal.

17. The audio device according to claim 16, further comprising an RF receiver, communicatively coupled to the at least one audio processor, for providing voice signals to the at least one acoustic transducer.

18. The audio device according to claim 16, wherein the at least one audio processor processes digitized audio information.

19. The audio device of claim 16, wherein the at least one acoustic resonator is located in proximity to the acoustic transducer by being adjacent to the acoustic transducer.
